(19) United States
(12) Patent Application Publication
(10) Pub. No.: US 2014/0307609 A1
(43) Pub. Date: Oct. 16, 2014

(54) MULTIMEDIA BROADCAST MULTICAST SERVICES VIA MULTIPLE TRANSMIT ANTENNAS

(71) Applicant: Alcatel-Lucent USA Inc., Murray Hill, NJ (US)

(72) Inventor: Ashok N. RUDRAPATNA, Basking Ridge, NJ (US)

(73) Assignee: Alcatel-Lucent USA Inc., Murray Hill, NJ (US)

(21) Appl. No.: 13/861,503

(22) Filed: Apr. 12, 2013

(51) Int. Cl. H04W 52/32; H04W 4/06; H04W 72/00

(52) U.S. Cl. CPC H04W 52/322; H04W 72/005; H04W 4/06
USPC 370/312

(57) ABSTRACT

A radio frequency equipment to transmit multimedia broadcast multicast services (MBMS) signals includes a precoding circuit and an antenna array. The precoding circuit is configured to generate a first precoded MBMS signal and a second precoded MBMS signal, and the antenna array is configured to broadcast the first and second precoded MBMS signals. The first and second precoded MBMS signals have different gain and phase shifts relative to one another.

### BACKGROUND

Multimedia broadcast multicast services (MBMS) are point-to-multipoint interface specifications for wireless technologies such as 3rd Generation Partnership Project Long-Term Evolution (3GPP LTE), wideband code divisional multiple access (WCDMA), universal mobile telecommunication system (UMTS), enhanced voice-data optimized (EVDO)/high rate packet data (HRPD), digital video broadcast (DVB), DVB-Terrestrial (DVB-T), DVB-Satellite (DVB-S), DVB-Satellite Services to Handhelds (DVB-SH), etc. For 3GPP LTE networks, the service is referred to as enhanced MBMS (eMBMS).

In these conventional systems, identical broadcast signals are transmitted from multiple base stations to user equipments in a synchronized manner to achieve what is referred to as a single frequency network (SFN). For eMBMS this is referred to as a multicast broadcast SFN (MBSFN). Such a transmission scheme yields power combining over the air resulting in improved signal-to-noise-plus-interference-ratio (SINR).

In conventional systems such as eMBMS, modes are defined only for single-input-multiple-output (SIMO) transmission format (i.e., transmission from a single antenna with reception by one or more antennas). These systems are not defined for transmit diversity (e.g., Alamouti code) or multiple-input-multiple-output (MIMO) schemes (i.e., transmission from multiple antennas with reception by multiple antennas). In base stations that support multi-antenna transmit schemes (e.g., MIMO) for unicast, only one transmit antenna is employed for eMBMS transmissions. This results in less total transmit power for eMBMS than for unicast. For example, in a base station that supports 2×2 MIMO for unicast, transmission power for eMBMS transmissions is about ½ the transmission power for unicast. In another example, for a base station that supports 4×4 MIMO, transmission power for eMBMS transmissions is about ¼ the transmission power for unicast.

There are many cases where transmit power has a significant impact on capacity, such as supportable spectral efficiency in an eMBMS system. Thus, employing the total transmit power across all the transmit chains will increase capacity.

### SUMMARY

At least one example embodiment provides a radio frequency equipment to transmit multimedia broadcast multicast services (MBMS) signals. According to at least this example embodiment, the radio frequency equipment includes: a precoding circuit configured to generate a first precoded MBMS signal and a second precoded MBMS signal, the first and second precoded MBMS signals having different (e.g., time-varying) gain and phase shifts relative to one another; and an antenna array configured to broadcast the first and second precoded MBMS signals.

At least one example embodiment provides a radio frequency equipment to transmit multimedia broadcast multicast services (MBMS) signals. According to at least this example embodiment, the radio frequency equipment includes: a precoding circuit configured to generate a first precoded MBMS signal and a second precoded MBMS signal by applying at least one fixed static phase difference to a MBMS signal; and an antenna array including a plurality of antennas arranged in a diversity mode configuration, the antenna array being configured to broadcast the first and second precoded MBMS signals.

At least one other example embodiment provides a method for broadcasting multimedia broadcast multicast services (MBMS) signals. According to at least this example embodiment, the method includes: generating, at a radio frequency equipment, a first precoded MBMS signal and a second precoded MBMS signal, the first and second precoded MBMS signals having different (e.g., time-varying) gain and phase shifts relative to one another; and broadcasting the first and second precoded MBMS signals.

At least one other example embodiment provides a method for broadcasting multimedia broadcast multicast services (MBMS) signals. According to at least this example embodiment, the method includes: generating, at a radio frequency equipment, a first precoded MBMS signal and a second precoded MBMS signal by applying at least one fixed static phase difference to a MBMS signal; and broadcasting, by a plurality of antennas arranged in a diversity mode configuration, the first and second precoded MBMS signals.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention.

FIG. 1 illustrates a portion of a multimedia broadcast multicast service (MBMS) architecture;

FIG. 2 illustrates a base station transmitter according to an example embodiment; and

FIG. 3 illustrates a base station transmitter according to another example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements (e.g., base stations, base station controllers, NodeBs, eNodeBs, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “base station” may be considered synonymous to, and may hereafter be occasionally referred to, as an evolved Node B, eNodeB, Node B, base transceiver station (BTS), etc., and describes a transceiver in communication with and providing wireless resources to mobiles in a wireless communication network spanning multiple technology generations. As discussed herein, base stations may have all functionally associated with conventional, well-known base stations in addition to the capability and functionality to perform the methods discussed herein.

It is noted that the specific names for base station in WCDMA is Node B (NB) and in LTE is enhanced Node B (eNB). The general name base station (BS) is used to include all applicable wireless technologies. Also in this disclosure, eMBMS is discussed for example purposes and used to represent other broadcast modes. It should be understood, however, that the techniques and methods discussed herein are applicable to various other broadcast modes, including but not limited to those discussed in this disclosure.

The term “user equipment,” as discussed herein, may be considered synonymous to, and may hereafter be occasionally referred to, as a client, mobile unit, mobile station, mobile user, mobile, subscriber, user, remote station, access terminal, receiver, etc., and describes a remote user of wireless resources in a wireless communication network.

Collectively, user equipments and base stations may be referred to herein as “transceivers” or “radio frequency equipments.”

Example embodiments provide methods, radio frequency equipments (e.g., base stations) and corresponding architectures for multimedia broadcast multicast services (MBMS) via multiple transmit antennas at the radio frequency equipments. Methods and architectures discussed herein enable more efficient utilization of transmit power at the base station for MBMS.

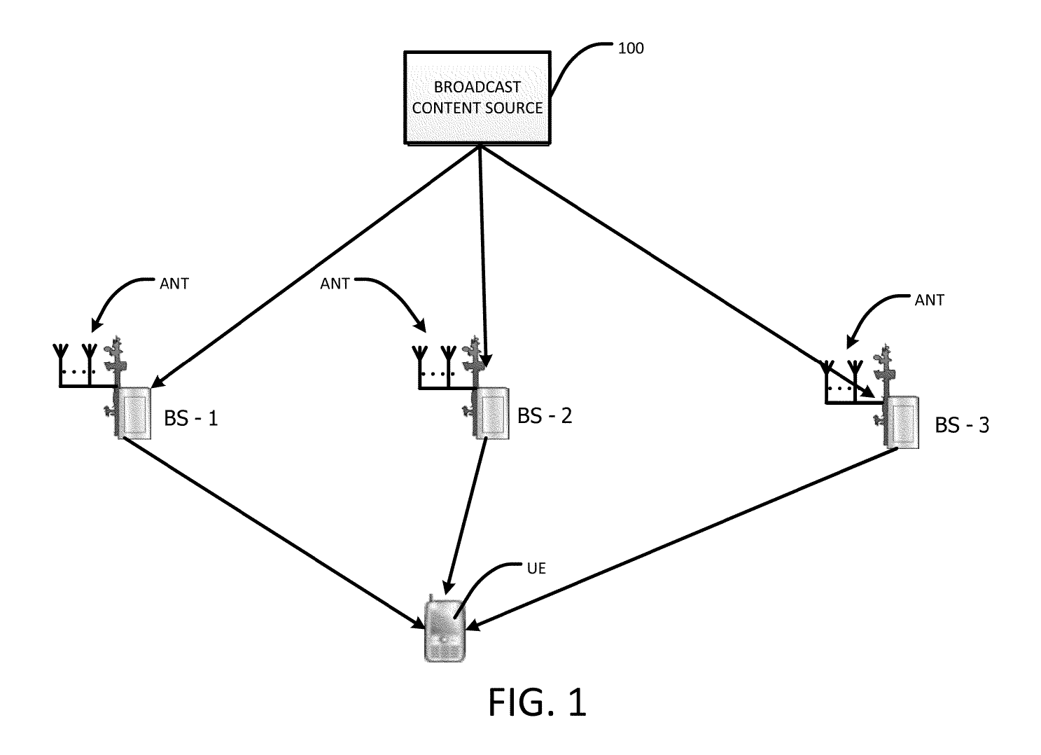

FIG. 1 illustrates a portion of a multimedia broadcast multicast service (MBMS) architecture.

Referring to FIG. 1, the MBMS architecture includes a broadcast content source 100 that provides multimedia broadcast content (e.g., video, audio, etc.) to a plurality of base stations BS-1, BS-2, and BS-3. The plurality of base stations BS-1, BS-2, and BS-3 provide broadcast transmission of the multimedia broadcast content to the user equipment UE.

The broadcast content source 100 may be any known content source configured to provide multimedia content to base stations over a communications link.

Each of the base stations BS-1, BS-2, and BS-3 provides radio access to user equipments, such as the user equipment UE within a given coverage area referred to as a cell. As is known, multiple cells may, and often are, associated with a single base station.

As shown, each of the base stations BS-1, BS-2 and BS-3 includes a transceiver antenna array ANT. Each of the transceiver antenna arrays ANT includes a plurality of transceiver antennas.

Each of the antenna arrays ANT may include a plurality of antennas. In one example, the plurality of antennas may be arranged in a diversity mode configuration. In another example, the plurality of antennas may be arranged in a non-diversity mode configuration. In still another example, the one or more of the antenna arrays ANT may include a first plurality of antennas arranged in a diversity mode configuration and a second plurality of antennas arranged in a non-diversity mode configuration. In yet another example, the antenna array ANT may be composed of several antenna sub-arrays. The antenna elements of each of the antenna sub-arrays may be arranged in a non-diversity mode configuration, while the antenna sub-arrays themselves are arranged with respect to each other in a diversity mode configuration.

In an example diversity mode configuration, a plurality of antennas may be arranged in a cross polarization (x-pol) configuration. Another example diversity mode configuration would be a pair of antennas including right-handed and left handed circular polarized antennas. In another example, the plurality of antennas may be arranged in a co-polarized (co-pol) configuration, but spaced sufficiently far apart so as to create a diversity mode configuration. In this example, the spacing between the antennas is based on the environment in which the antenna array ANT is arranged. In yet another example, an antenna array ANT may include a first plurality of antennas configured in a cross-polarized diversity mode configuration and a second plurality of antennas configured in a co-polarized diversity mode configuration.

When the antennas of an antenna array at a base station are arranged in the diversity mode configuration, identical transmitted signals are received in an uncorrelated manner at the receiver (e.g., user equipment). Due to the diversity configuration at the base station, the transmitted eMBMS signals do not combine to form static standing waves causing potential destructive interference. Instead, the signals from each antenna combine in power with signals from other antennas of the same base station and contribute to the single frequency network (SFN) gains, thereby improving overall signal-to-noise-plus-interference-ratio (SINR) at the receiver.

In an example non-diversity mode configuration, antennas of an antenna array may be arranged in a co-polarized configuration, but spaced sufficiently closely to permit creating directed beams between the antennas. In such non-diversity mode configurations, transmissions are received in a correlated manner at the receiver, which may result in formation of standing waves with potential destructive interference areas in areas of beam formed nulls that reduce signal strength.

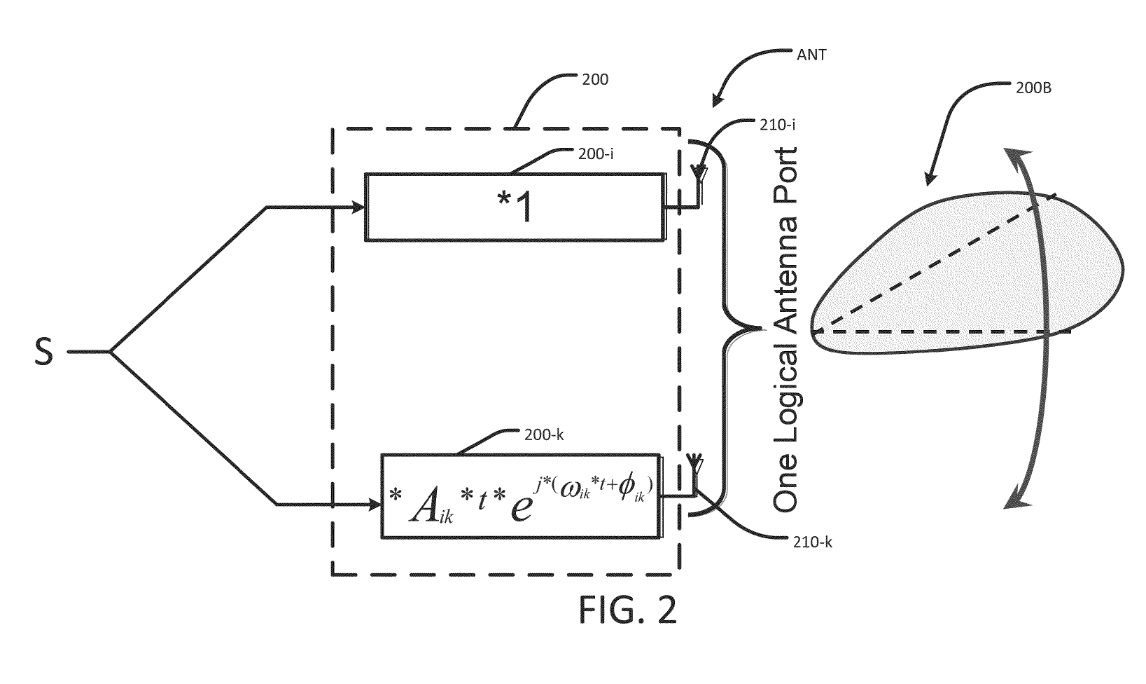

FIG. 2 illustrates an example embodiment of a base station transmitter according to an example embodiment. The example embodiment shown in FIG. 2 will be described in detail with regard to the base station transmitter at base station BS-1 in FIG. 1. However, it will be understood that each of the base stations may be configured similarly.

In the example shown in FIG. 2, the base station transmitter includes the antenna array ANT and a precoding circuit 200. The antenna array ANT includes transceiver antennas 210-i and 210-k, and the precoding circuit 200 includes precoders 200-i and 200-k. Each of the precoders 200-i and 200k corresponds to one of transceiver antennas 210-i and 210-k. Example operation of the base station transmitter shown in FIG. 2 will be discussed in more detail below.

The precoding circuit 200 is configured to generate a first precoded multimedia broadcast multicast services signal and a second precoded multimedia broadcast multicast services signal, wherein the first and second precoded multimedia broadcast multicast services signals have different time-varying gain and phase shifts relative to one another.

The antennas 210-i and 210-k in FIG. 2 may be configured in a diversity mode or non-diversity mode configuration. The base station transmitter employs phase shift transmit diversity (PSTD) across the antenna array ANT, wherein each precoder multiplies a received signal by a different time-varying gain and phase shift, and supplies the gain and phase shifted signal to a respective one of the physical antennas 210-i and 210-k.

Referring to FIG. 2 in more detail, each of the precoders 200-i and 200k receives an eMBMS signal S in parallel. Each of the precoders 200-i and 200k multiplies the eMBMS signal S by a different time-varying gain and phase shift (or precodes), and supplies the gain and phase shifted signal to a respective one of the physical antennas 210-i and 210-k. The resulting signal from the two physical antennas 210-i and 210-k form one logical antenna port.

In the example shown in FIG. 2, the precoder 200-i generates a gain and phase shifted (or precoded) signal PSᵢ by pre-multiplying the signal S by a gain of 1 and a phase shift of 0° (without a gain or phase shift), whereas the precoder 200k generates a time varying gain and phase shifted signal PSₖ according to Equation (1) shown below.

PSₖ=S*Aᵢₖ*t*e^{j*(ω}^{ᵢₖ}^{*t+φ}^{ᵢₖ}⁾ (1)

The gain and phase shifted signals may also be referred to herein as precoded signals. In this example, the precoder 200-i pre-multiplies the signal S by 1, and thus, does not gain/phase shift the eMBMS signal S.

In Equation (1), the eMBMS signal S is the original signal associated with the antenna port, Aᵢₖ*t is the time varying gain shift or gain across the antenna array ANT, t is time, and (ωᵢₖ*t+φᵢₖ) is the time varying phase shift, where ωᵢₖ is a phase change rate across the antenna array ANT, and φᵢₖ is the static phase offset across the antenna array ANT. As shown in Equation (1), the phase of the phase shifted signal PSₖ may increase linearly with time.

The precoded signal PSᵢ is then transmitted (broadcast) to receivers (e.g., user equipment UE) by transceiver antenna 210-i, and the precoded signal PSₖ is transmitted (broadcast) to receivers by transceiver antenna 210-k. This results in the beam 200B sweeping across the sector over time.

In accordance with the example embodiment shown in FIG. 2, a beam may be formed by any pair of antennas, wherein the beams sweep the sector area at a certain rate. Each such pair of antennas forms a beam that sweeps, but at gains, offsets and rates as chosen for the pair. The net effect is for all power to be combined non-coherently; that is, in power over the air improving the SINR at the receiver. It is noted that the same signal S to be broadcast is applied across all antennas of the antenna array ANT.

The methodology discussed above with regard to the example embodiment shown in FIG. 2 may be used with diversity antenna configurations as described above or for non-diversity antenna configurations in which the transmissions from such antennas are received in a correlated manner at the receiver. This differential gain and phase arrangement may be applied across antennas within the same base station or across antennas at (across) multiple base stations operating within the same SFN arrangement.

In at least one other example embodiment, identical eMBMS signals, with or without static phase offsets between them, are transmitted from all antennas at a base station. This example embodiment is employed when the transmit antennas are arranged in a diversity mode configuration (e.g., a cross-polarization configuration and/or a co-polarization configuration with sufficient spacing). It is noted that this example embodiment is a special case of Equation (1) discussed above, wherein Aᵢₖ=1, and ωᵢₖ=0.

As mentioned above, when antennas are arranged in a diversity mode configuration, the transmissions from antennas are received in an uncorrelated manner at the receiver. Because of the diversity mode configuration, the eMBMS signals do not combine to form static standing waves causing potential destructive interference. Instead, the eMBMS signals from each antenna combine with signals from other base stations and contribute to the SFN gains, thereby improving overall SINR at the receiver.

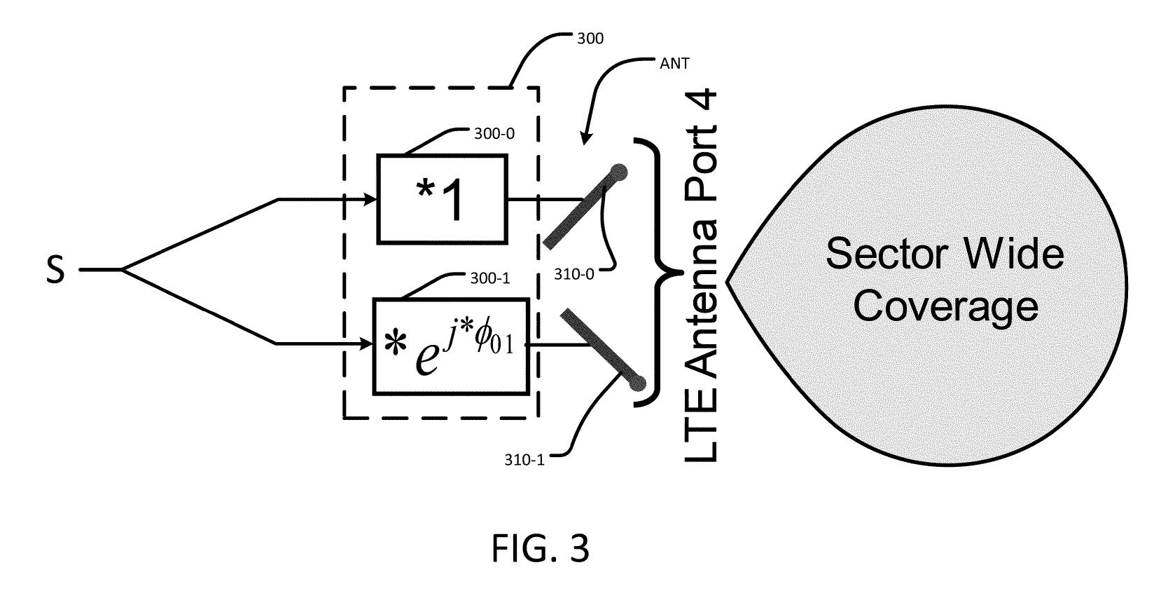

FIG. 3 illustrates another example embodiment of a base station transmitter. In this example, the antenna array ANT includes a plurality of antennas arranged in a cross-polarization (diversity mode) configuration. The base station transmitter further includes a precoding circuit 300.

The antenna array ANT includes transceiver antennas 310-0 and 310-1, and the precoding circuit 300 includes precoders 300-0 and 300-1.

The precoding circuit 300 is configured to generate a first precoded multimedia broadcast multicast services signal and a second precoded multimedia broadcast multicast services signal by applying at least one fixed static phase (or phase difference) to a multimedia broadcast multicast services signal.

Each of the precoders 300-0 and 300-1 corresponds to one of transceiver antennas 310-0 and 310-1. The antennas 310-0 and 310-1 are arranged in a cross-polarization configuration. However, it should be understood that the antennas may be arranged in any diversity mode configuration. Example operation of the base station transmitter shown in FIG. 3 will be discussed in more detail below

In the example embodiment shown in FIG. 3, each of the precoders 300-0 and 300-1 receives an eMBMS signal in parallel, and applies a fixed static phase (or phase difference) φ₀₁ to the received eMBMS signal S. The fixed, static phase (or phase difference) may be 0° or a fixed value.

In the example shown in FIG. 3, the precoder 300-0 does not apply a fixed static phase (or phase difference) to obtain the precoded signal PS₀, whereas the precoder 300-1 applies a fixed static phase (or phase difference) φ₀₁≠0 by pre-multiplying the eMBMS signal S by e^{j*φ}^{₀₁} as shown below in Equation (2) to generate the precoded signal PS₁.

PS₁=S*e^{j*φ}^{₀₁} (2)

The precoded signal PS₀ is then transmitted (broadcast) to receivers by transceiver antenna 310-0, and the precoded signal PS₁ is transmitted (broadcast) to receivers by transceiver antenna 310-1.

Each of the antennas 310-0 and 310-1 in FIG. 3 is a sector coverage type antenna. Because the antennas 310-0 and 310-1 are arranged in a cross-polarized antenna configuration, the resulting combined signal over the two antennas also provides sector-wide coverage.

Like the example discussed above with regard to FIG. 2, the multiple antenna combined signal transmission scheme will be seen by the receiver (e.g., user equipment UE) as a single virtual antenna or one logical antenna port.

The resulting polarization (e.g., linear, circular, elliptical, etc.) of the combined signal is based on the sum of the value of the fixed static phase (or phase difference) φ₀₁ and any phase (or phase difference) between the two transmit path chains from the baseband modem to their respective antenna. This delivers the sum of the two transmit chain's power to the receiver for the MBSFN service.

According to at least some example embodiments, the methodologies described with regard to FIGS. 2 and 3 may be used in combination. For example, the methodology described above with regard to FIG. 2 may be applied to antenna sub-arrays having non-diversity configurations (e.g., closely spaced co-polarized antennas) and the methodology described above with regard to FIG. 3 may be applied to antenna sub-arrays having diversity configurations.

Each of the methods described herein, by itself or in combination, yield power combining gains across all or substantially all the transmit chain powers equivalent to SFN combining.

According to at least some example embodiments, while the cumulative signal is transmitted (broadcast) over multiple physical antennas, the cumulative signal appears to the receiver (e.g., a user equipment or other radio frequency equipment) as if having been transmitted by a single antenna. Thus, the multiple antenna transmission scheme can be viewed as a single virtual antenna or one logical antenna port.

Such schemes are essentially base station precoders that are transparent to user equipments and do not impact standards, but improve performance.

The foregoing description of example embodiments has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

I claim:

1. A radio frequency equipment to transmit multimedia broadcast multicast services (MBMS) signals, the radio frequency equipment comprising:
a precoding circuit configured to generate a first precoded MBMS signal and a second precoded MBMS signal, the first and second precoded MBMS signals having different gain and phase shifts relative to one another; and
an antenna array configured to broadcast the first and second precoded MBMS signals.

2. The radio frequency equipment of claim 1, wherein the antenna array comprises:
a plurality of antennas arranged in a diversity mode configuration.

3. The radio frequency equipment of claim 1, wherein the antenna array comprises:
a plurality of antennas arranged in a non-diversity mode configuration.

4. The radio frequency equipment of claim 1, wherein the antenna array comprises:
at least one first antenna configured to broadcast the first precoded MBMS signal; and
at least one second antenna configured to broadcast the second precoded MBMS signal.

5. The radio frequency equipment of claim 4, wherein the first antenna and the second antenna are arranged in a diversity mode configuration.

6. The radio frequency equipment of claim 4, wherein the first antenna and the second antenna are arranged in a non-diversity mode configuration.

7. The radio frequency equipment of claim 1, wherein the precoding circuit is configured to generate the first and second precoded MBMS signals by applying different gain and phase shifts to a same MBMS signal.

8. The radio frequency equipment of claim 7, wherein the precoding circuit comprises:
a first precoder configured to multiply the MBMS signal by a first gain and phase shift to generate the first precoded MBMS signal; and
a second precoder configured to multiply the MBMS signal by a second gain and phase shift to generate the second precoded MBMS signal; wherein
the first gain and phase shift is different from the second gain and phase shift.

9. The radio frequency equipment of claim 8, wherein a gain shift of the first gain and phase shift is 1 and a phase shift of the first gain and phase shift is 0°.

10. The radio frequency equipment of claim 1, wherein at least one of the first gain and phase shift and the second gain and phase shift changes over time.

11. A radio frequency equipment to transmit multimedia broadcast multicast services (MBMS) signals, the radio frequency equipment comprising:
a precoding circuit configured to generate a first precoded MBMS signal and a second precoded MBMS signal by applying at least one fixed static phase to a MBMS signal; and
an antenna array including a plurality of antennas arranged in a diversity mode configuration, the antenna array being configured to broadcast the first and second precoded MBMS signals.

12. The radio frequency equipment of claim 11, wherein the precoding circuit comprises:
a first precoder configured to apply a first static phase to the MBMS signal to generate the first precoded MBMS signal; and
a second precoder configured to apply a second static phase to the MBMS signal to generate the second precoded MBMS signal; wherein
the first static phase is different from the second static phase.

13. The radio frequency equipment of claim 11, wherein the first static phase is 0.

14. A method for broadcasting multimedia broadcast multicast services (MBMS) signals, the method comprising:
generating, at a radio frequency equipment, a first precoded MBMS signal and a second precoded MBMS signal, the first and second precoded MBMS signals having different gain and phase shifts relative to one another; and
broadcasting the first and second precoded MBMS signals.

15. The method of claim 14, wherein the first and second precoded MBMS signals are generated by applying different gain and phase shifts to a same MBMS signal.

16. The method of claim 15, wherein the generating step comprises:
multiplying the MBMS signal by a first gain and phase shift to generate the first precoded MBMS signal; and
multiplying the MBMS signal by a second gain and phase shift to generate the second precoded MBMS signal; wherein
the first gain and phase shift is different from the second gain and phase shift.

17. The method of claim 14, wherein at least one of the first gain and phase shift and the second gain and phase shift changes over time.
